(19) United States
(12) Patent Application Publication
(10) Pub. No.: US 2025/0078238 A1
(43) Pub. Date: Mar. 6, 2025

(54) ENHANCED OPTICAL FIBER INSPECTION USING IMAGE SEGMENTATION

(71) Applicant: EXFO Inc., Quebec (CA)

(72) Inventors: Jonathan PLANTE, Montreal (CA); Sylvain NADEAU, Vaudreuil-Dorion (CA); Justin M. WHATLEY, Wolfville (CA)

(73) Assignee: EXFO Inc., Quebec (CA)

(21) Appl. No.: 18/813,432

(22) Filed: Aug. 23, 2024

Related U.S. Application Data
(60) Provisional application No. 63/535,667, filed on Aug. 31, 2023.
(60) Provisional application No. 63/620,972, filed on Jan. 15, 2024.

(51) Int. Cl. G06T 7/00; G01M 11/00; G06V 10/24; G06V 10/26; G06V 10/764; G06V 10/774; G06V 10/82

(52) U.S. Cl. CPC G06T 7/0002; G01M 11/30; G06V 10/242; G06V 10/273; G06V 10/764; G06V 10/774; G06V 10/82; G06T 2207/20081; G06T 2207/20084

(57) ABSTRACT

Systems and methods for inspecting optical fibers are provided. A method, according to one implementation, includes steps of obtaining an image of an end-face of an optical fiber; analyzing the image with a pre-trained neural network model to classify pixels therein as any of a defect, a scratch, or clean; aggregating the pixels based on proximity to obtain defect segments or scratch segments; characterizing these defect segments and scratch segments based on but not limited to size and location, and providing an output including any of the defect segments or scratch segments.

### CROSS-REFERENCE

The present disclosure claims priority to U.S. Provisional Patent Application No. 63/535,667, filed Aug. 31, 2023, and to U.S. Provisional Patent Application No. 63/620,972, filed Jan. 15, 2024, the contents of each are incorporated by reference in their entirety.

### TECHNICAL FIELD

The present disclosure generally relates to systems and methods for testing optical fibers. More particularly, the present disclosure relates to using Artificial Intelligence (AI) image segmentations techniques to inspect optical fibers.

### BACKGROUND

Generally, many fiber inspection probes are typically configured to analyze images of an end-face of an optical fiber, fiber optic cable, or the like. An objective of fiber inspection is to determine whether the fiber end-face is capable of effectively transmitting light for telecommunication systems. To perform fiber inspection, images are captured of the end-face with an optical device having some magnification strength. Then, the images are usually processed using classical image processing algorithms, such as thresholding, edge detection, pattern matching, etc., to determine if the fiber end-face passes or fails certain industry standard in terms of cleanliness or a small amount of irregularities. To achieve this, the fiber core can be detected using a circle detection algorithm. From the center of the core, regions are determined in accordance with the industry standard. Classical signal processing methods are used to detect and measure defects and scratches in those regions. The defects and scratches are counted in all regions, and, depending on the region, different sizes and amounts of defects and scratches might be tolerated. The industry standards may include a certain threshold to which the inspected end-face can be compared. The threshold may be used to determine whether the end-face (or the optical fiber itself) meets the standards and may define pass/fail criteria.

The classical approach can be easily fooled with a so-called “shadowing effect” where the classical approach tends to falsely detect defects and scratches when there are shadows present in the image. For example, the shadowing effect can be due to a fiber inspection probe being at a slight angle relative to a fiber endpoint. Also, some may perform repeated tests with a fiber inspection probe of the same fiber, and, of course, the expectation is the fiber inspection probe provides the same answer. However, due to shadows (i.e., false triggering artifacts), focus settings, etc., the fiber inspection probe does not always provide the same response. Further, with new hardware, new fibers, new connectors, etc., the fiber inspection probe detection process must be updated, such as via rules requiring significant time for fine-tuning and human involvement. As such, existing approaches do not scale to new cases and the existing approaches are not robust.

### BRIEF SUMMARY

The present disclosure is directed to systems and methods for inspecting the condition of an end-face of a fiber optic cable. In particular, the present disclosure includes a fiber inspection probe and associated method where fiber end-face images are analyzed for defects and scratches using a Convolutional Neural Networks (CNNs) image segmentation processing approach, wherein the image segmentation processing approach determines the likelihood of each pixel within the image being classified as a defect, a scratch, or clean (neither defect nor scratch). To that end, the image segmentation processing approach includes a machine learning segmentation model pre-trained with real image background (representing real usage conditions) combined with synthetic defect and scratch insertion.

In an embodiment, the present disclosure includes a method of inspecting fibers that includes various steps and a non-transitory computer-readable medium including instructions that, when executed, cause one or more processors to implement the steps. In another embodiment, an optical fiber inspection device includes an end-face imaging device configured to capture an image of an end-face of an optical fiber; a processing device; a memory device configured to store a computer program having instructions that enable the processing device to execute the steps.

The steps include obtaining an image of an end-face of an optical fiber; analyzing the image with a pre-trained neural network model to classify pixels therein as any of a defect, a scratch, or clean; aggregating the pixels based on proximity to obtain defect segments or scratch segments; and providing an output including any of the defect segments or scratch segments. The steps can further include, based on applicable industry standards in terms of a number of defects and scratches and their corresponding size and location, providing a pass or fail assessment of the end-face of the optical fiber.

The providing the output can include providing an output image including the end-face of the optical fiber and an overlay showing any of the defect segments or scratch segments. The any of the defect segments or scratch segments can be visually distinguished in the overlay. The steps can further include, prior to the analyzing and during training of the pre-trained neural network model, obtaining augmented images that include real images of end-faces of optical fibers which are augmented with data including synthetic defects or scratches and which are labeled accordingly; and training the neural network model with the augmented images. The steps can further include creating the augmented images by obtaining real images of an end-face of an ideal optical fiber; adding synthetic defects and scratches to the real images to create training images with appropriate labels; and training the neural network model via supervised learning using the training images with the appropriate labels.

The steps can further include determining if one or more stress rods or any other structural elements are present in the optical fiber; and masking or ignoring any pixels representing the one or more stress rods from further analysis. The analyzing the image with the pre-trained neural network model to classify pixels can include rotating the image multiple times and processing the rotated image accordingly with the pre-trained neural network model. The aggregating the pixels based on proximity can utilize segmentation maps.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1A is a diagram showing an end-face of a single-mode optical fiber, according to various embodiments.

FIG. 1B is a diagram showing an end-face of a multi-mode optical fiber, according to various embodiments.

FIGS. 2A and 2B are diagrams showing examples of fiber inspection probes for inspecting an end-face of an optical fiber.

FIG. 3 is a block diagram illustrating an optical fiber testing device, according to various embodiments.

FIG. 4 is a block diagram illustrating the end-face inspection program shown in FIG. 3, according to various embodiments.

FIGS. 5A and 5B are images of a fiber under test showing examples of an end-face of an optical fiber under test, for demonstrating the shadowing effect.

FIGS. 6A-6D are images of a fiber under test showing examples of data inputs for training an ML model.

FIG. 7 is a flow diagram illustrating a method for inspecting an end-face of an optical fiber under test, according to various embodiments.

### DETAILED DESCRIPTION

The present disclosure relates to systems and methods for determining whether or not an end-face of an optical fiber or fiber optic cable is capable of effectively transmitting light for telecommunication systems, i.e., meeting applicable standards. For example, the present disclosure describes optical fiber testing devices, Fiber Inspection Probes (FIPs), fiber inspection scopes, etc. These systems may include an end-face imaging device or other image capture device for capturing an image of the end-face. In some embodiments, the systems may further include processing devices and memory devices for running tests based on the captured end-face images. The memory device may be a non-transitory computer-readable medium for storing computer logic having instructions for enabling the processing device to perform fiber inspection techniques. In one implementation, the processing device may be configured to a) obtain a captured image of an end-face, b) classify each pixel of the captured image as either clean (e.g., acceptable, good, etc.) or defect or scratch, and c) perform an image segmentation procedure by aggregating pixels based on proximity to classify defect segments or scratch segments within the captured image.

Further, the present disclosure includes training with real image background data, which provides a better representation of real usage conditions. In addition to the real image training data, these images are inserted with synthetic defects and/or scratches, which are added for the purpose of training a ML model to perform an image segmentation technique. Furthermore, the present disclosure is believed to provide additional benefits in the field of fiber optic testing by allowing the ML to be fine-tuned or retrained for adjusting to unforeseen variations of fiber end-face characteristics. It is believed that the embodiments of the present disclosure provide systems and methods that are novel in the field of fiber optic testing and provide benefits and advantages over conventional systems. In fact, during experimentation, the present systems and methods showed an improvement in accuracy and repeatability over conventional systems to provide a more robust solution for both multimode fibers and single-mode fibers.

In particular, the systems and methods described herein include a process of training ML models to recognize defects and scratches on fiber end-face images, while also disregarding the presence of undesirable optical effects (e.g., shadowing). Thus, the present disclosure provides solutions for fiber inspection probes/scopes where the fiber end-face images are analyzed for defects or scratches. The systems may use a Neural Network (NN) (e.g., Convolutional Neural Network (CNN)) for image segmentation, wherein the image processing methods may calculate the likelihood of each pixel within the image being classified as a defect, a scratch, or clean (neither defect nor scratch). A segmentation map can be created for each class.

Optionally, the method may also include a self-cross validation process, where the end-face image is rotated multiple times and passed through the NN model, and then the NN model outputs are averaged to determine the final classification of each pixel. Of note, there can be other approaches to aggregate these outputs other than averaging. For each pixel, the threshold is then applied to the averaged outputs. The method includes combining like adjacent pixels into segments, the measurement of these segments classified as a defect or scratch, and the comparison to the applicable industry standard. The pixels associated with defects or scratches may be identified on the fiber end-face images in red for the defects and scratches (e.g., considered as faults by the selected/applicable industry standard) and may be identified in green otherwise.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

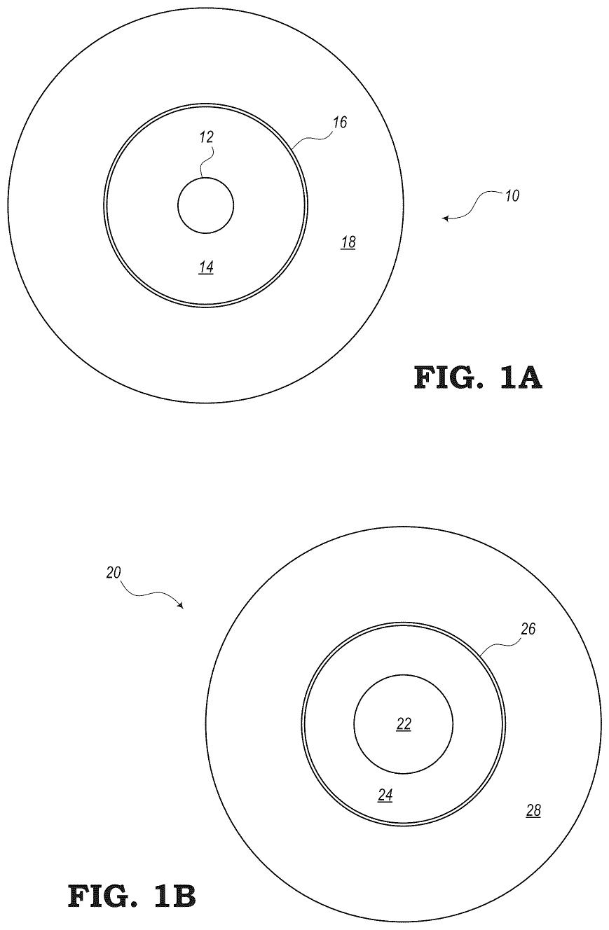

FIG. 1A is a diagram showing an example of an end-face of a single-mode optical fiber 10. As shown, the single-mode optical fiber 10 includes a number of different regions. A first region of the single-mode optical fiber 10 includes a core 12, which is relatively small compared with multi-mode fibers and is generally cylindrical. A second region of the single-mode optical fiber 10 includes cladding 14 that surrounds the core 12 and has a generally tubular shape. A third region is an adhesive 16 (or epoxy) on the outside surface of the cladding 14 and has a generally tubular shape. A fourth region is a contact area 18, which is generally tubular. The contact area 18 surrounds the cladding 14 and is attached to the outer surface of the cladding 14 by the adhesive 16.

FIG. 1B is a diagram showing an example of an end-face of a multi-mode optical fiber 20. Like the single-mode optical fiber 10, the multi-mode optical fiber 20 includes a number of different regions. A first region of the multi-mode optical fiber 20 includes a core 22, which is generally cylindrical. A second region of the multi-mode optical fiber 20 includes cladding 24 that surrounds the core 22 and has a generally tubular shape. A third region is an adhesive 26 (or epoxy) on the outside surface of the cladding 24 and has a generally tubular shape. A fourth region is a contact area 28, which is generally tubular. The contact area 28 surrounds the cladding 24 and is attached to the outer surface of the cladding 24 by the adhesive 26.

Of course, the single-mode optical fiber 10 and the multi-mode optical fiber 20 are shown for illustration purposes and those skilled in the art will recognize various other types of optical fibers are contemplated herewith.

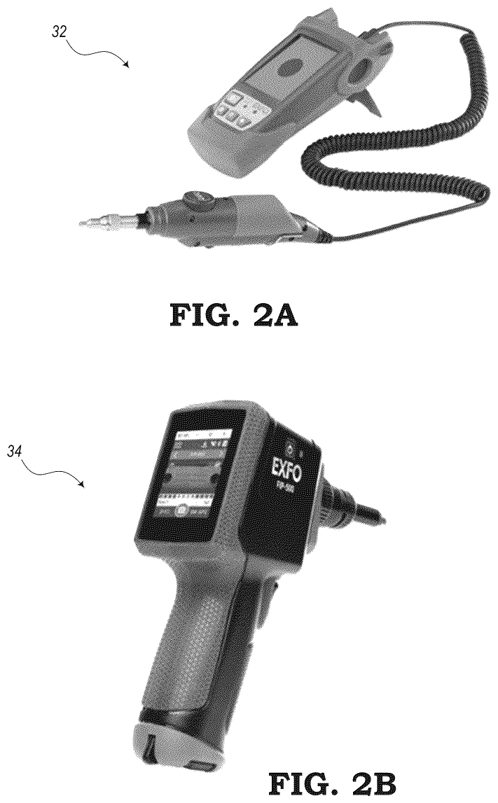

FIGS. 2A and 2B are diagrams showing examples of fiber inspection probes 32, 34 for inspecting an end-face of an optical fiber. For example, the fiber inspection probes 32, 34 may include image capturing devices for capturing an image of an end-face of an optical fiber under test (not shown). The captured images can be forwarded to processors and/or memory, which may be positioned inside suitable housings. Also, the processors may perform an image segmentation procedure by aggregating pixels classified as a defect or scratch into one or more segment groups. Each segment group may be formed by those unsatisfactory pixels that are located adjacent to or near each other. The images of the end-faces can be displayed on a suitable output device, display device, user interface, or the like. Also, the display device may also be configured to display other information, such as color-coded graphics indicating the location of the different regions (e.g., core, cladding, adhesive, coating area, etc.) of the optical fiber as well as detected defects (e.g., dust, lint, dirt, oil, salt, smudge, streak, etc.) and scratches (e.g., visible line or mark on the polished surface).

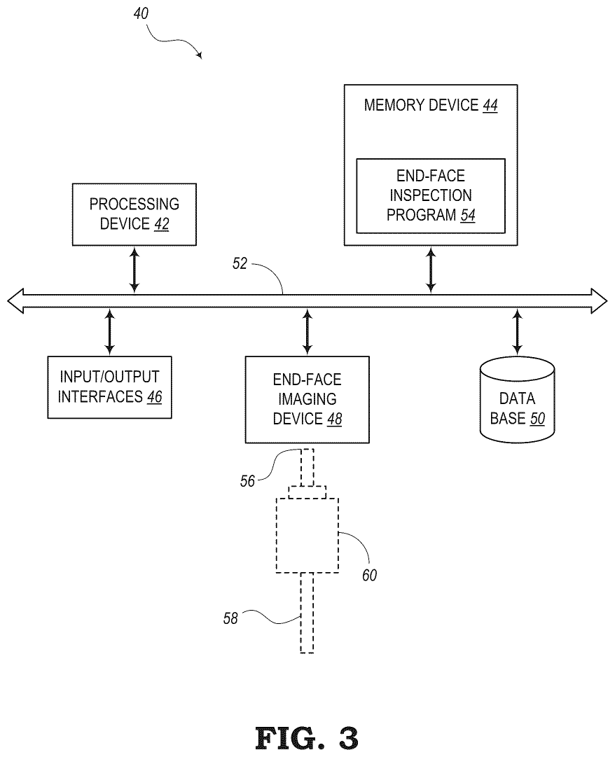

FIG. 3 is a block diagram illustrating an embodiment of an optical fiber testing device 40. In the illustrated embodiment, the optical fiber testing device 40 may be a digital computing device or embedded system that generally includes a processing device 42, a memory device 44, Input/Output (I/O) interfaces 46, and an end-face imaging device 48. In some embodiments, the optical fiber testing device 40 may also include a database 50. It should be appreciated that FIG. 3 depicts the optical fiber testing device 40 in a simplified manner, where some embodiments may include additional components and suitably configured processing logic to support known or conventional operating features. The components (i.e., 42, 44, 46, 48) may be communicatively coupled via a local interface 52. The local interface 52 may include, for example, one or more buses or other wired or wireless connections. The local interface 52 may also include controllers, buffers, caches, drivers, repeaters, receivers, among other elements, to enable communication. Further, the local interface 52 may include address, control, and/or data connections to enable appropriate communications among the components 42, 44, 46, 48.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

The optical fiber testing device 40 further includes an end-face inspection program 54, which may be implemented in any suitable combination of hardware (e.g., in the processing device 42) and software/firmware (e.g., in the memory device 44). In some embodiments, the end-face inspection program 54 may be stored in a non-transitory computer-readable medium (e.g., the memory device 44) and include computer logic or code having instructions that, when executed, cause or enable the processing device 42 to perform various end-face inspection processes as described throughout the present disclosure.

The end-face imaging device 48 may be configured to capture an image of an end-face 56 of an optical fiber 58 under test. In some embodiments, the optical fiber 58 may include a connector 60 that may be attached to the optical fiber testing device 40 to fix the optical fiber 58 next to the end-face imaging device 48 and thereby enable the end-face imaging device 48 to capture the image more easily.

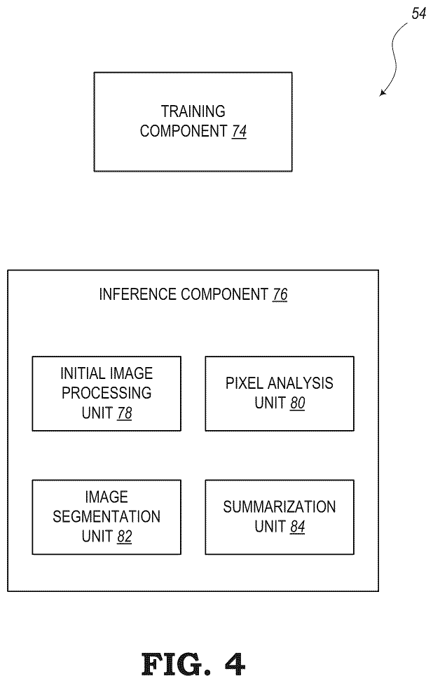

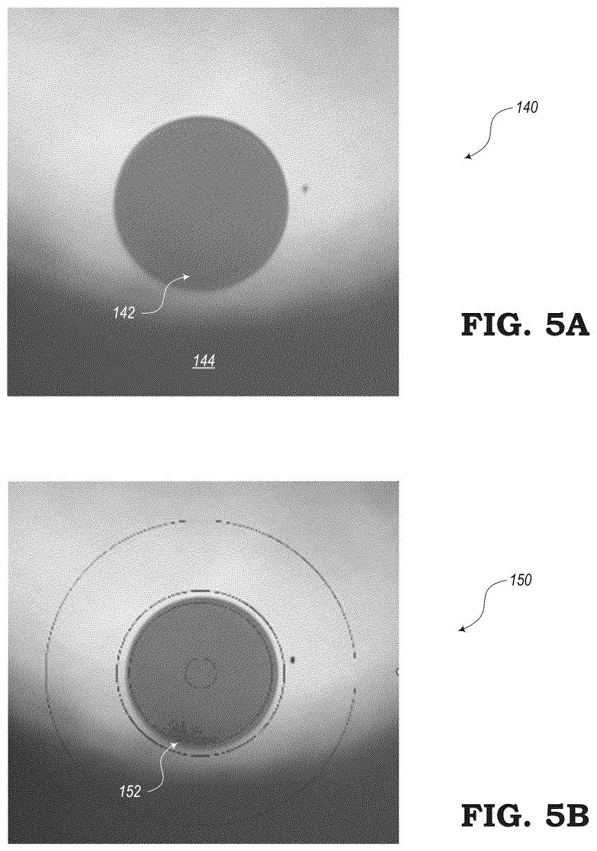

FIG. 4 is a block diagram illustrating an embodiment of the end-face inspection program 54 shown in FIG. 3. In this embodiment, the end-face inspection program 54 may include a training component 74 (described in more detail below with respect to FIG. 5). Also, the end-face inspection program 54, in this implementation, may include an inference component 76. As shown, the inference component 76 includes an initial image processing unit 78, a pixel analysis unit 80, an image segmentation unit 82, and a summarization unit 84.

FIGS. 5A and 5B are images 140, 150 showing examples of an end-face of an optical fiber under test, e.g., the image 140 being an image for analysis and the image 150 showing the analysis being done. Since the conventional approach can be fooled by the “shadowing effect” 142, 144 or other various artifacts, the classical approach may tend to falsely detect defects 152, when there are simply shadows present in the image. This shadowing effect 142, 144 is due to an optical fiber inspection device being at a slight angle when capturing the fiber endpoint.

In addition, some users may do repeatability tests to evaluate the performance of the optical fiber inspection device itself, where they analyze the same fiber multiple times. They expect the FIP to provide the same answer. However, due to the presence of false triggering artifacts, due to shadows, out of focus, etc., the optical fiber inspection device sometimes does not provide the same response.

Finally, when hardware is changed, or new fibers or connectors are manufactured, the optical fiber inspection device detection algorithm may need to be tuned accordingly. The parameters of the rule-based methods may be modified and then tested. This approach can be quite time-consuming as a human is needed to design and fine-tune these algorithms.

The current drawbacks in the conventional systems are that they do not adjust or generalize well to various situations. When edge cases arise, an expert must take time to adjust the algorithm or create a new one. An edge case is a scenario where something that shouldn't be detected as at a scratch or defect is detected. For example, one edge case that was observed was a new fiber connecter producing a more luminous core. This artifact that was not ever observed was being detected as defect when in fact it was not. This could happen with other characteristics that are normal but were never included in the training set. Another scenario is the opposite, namely where defects and scratches are missed because of some phenomenon such as hardware change or something else. The latter occurs less often.

Another issue is that the conventional approaches are typically not robust to artifacts such as shadowing effects or the image being out of focus, etc., thus creating false detections of defects and scratches or providing inconsistent results when repeating tests on the same end face. Another drawback is that the algorithm's performance is dependent on the resolution of the image. Note, the present disclosure also has some performance based on resolution of the image but performs with better tolerance to lower resolution than the conventional approaches. Lastly, the conventional algorithms may be tuned to the hardware, making them very sensitive to hardware changes.

Thus, it may be seen that the systems and methods of the present disclosure are configured to overcome many of the issues with conventional systems. The present systems and methods can train ML models to recognize defects and scratches on end-face fiber images, while disregarding the presence of undesirable optical effects like shadowing. For training, semi-synthetic data may be used, enabling a supervised learning approach. The training dataset may be composed of various clean real end-face fiber images on which synthetic blobs and circles are added as defects and lines as scratches. Synthetic defects and scratches are randomly placed and generated (e.g., having various lengths, widths, shapes, colors, etc.). The clean real end-face fiber images include examples of undesirable optical effects.

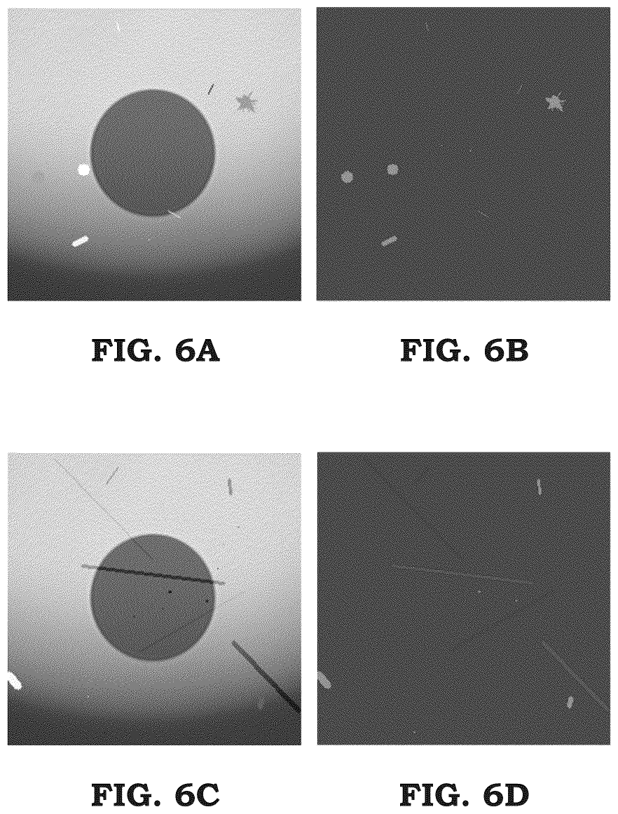

FIGS. 6A-6D are images showing examples of data for training an ML model with supervised learning. Examples of ground truth images, where the blue portions represent pixels that are labeled as background (clean), the green portions represent pixels that are labelled as defects, and the red portions represent scratches. Thus, the examples shown in FIG. 6A-6D illustrate ground truth images with synthetic defect/scratches added. FIGS. 6A and 6C are inputs to the model whereas FIGS. 6B and 6D are the ground truths to what the output of the model is trained against.

Then, the trained ML model can be used at inference as described herein to determine which groups of pixels are associated with defects, scratches or are clean (e.g., free of irregularities). A segmentation map for each class (clean, defect, scratch) may contain the probability of that pixel belonging to that class. The identified defects and scratches are measured and counted to be compared with the industry standard.

Therefore, the present disclosure may be a fiber inspection probe/scope where the fiber end-face images are analyzed for contamination using a Convolutional Neural Networks (CNNs) image segmentation processing method, wherein the image processing method may calculate the likelihood of each pixel within the image being classified as a defect, a scratch, or clean (neither defect nor scratch). A segmentation map for each class may be obtained.

Optionally, the method includes self-cross validation, where the end-face image is rotated multiple times and passed through the CNN, and then the CNN outputs are averaged (or other approaches) to determine the final classification of each pixel. For each pixel, the corresponding outputs of the models are summed and then divided by the total number of outputs. The threshold is then applied to this averaged output.

The method includes the individual measurement of each group of pixels classified as a defect or scratch. The resulting defects and scratches are measured and counted and compared to the applicable industry standard. The defects are formed by aggregating all adjacent pixels that have been classified as a defect. The length and width of the defects in terms of pixels can be translated to meters and applied to the standard. The same method is applied for scratches. The aggregation of defects and scratch pixels can be done with other algorithms as well. The pixels associated with defects or scratches are identified on the fiber end-face images in red for the defects and scratches considered as faults by the selected/applicable industry standard, and in green for the others.

Optionally, when support cases of new end face characteristics arise, it is possible to further train the model to improve on these cases. The mitigation approach involves using a labelling tool to annotate a sample of images and then do a data driven training.

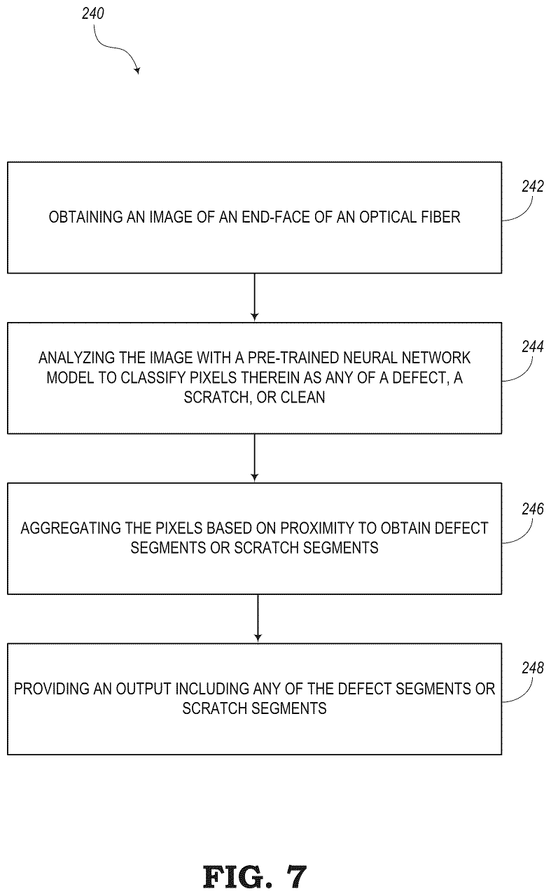

FIG. 7 is a flow diagram illustrating an embodiment of a method 240 for inspecting an end-face of an optical fiber under test. The method 240 includes steps of obtaining an image of an end-face of an optical fiber (step 242); analyzing the image with a pre-trained neural network model to classify pixels therein as any of a defect, a scratch, or clean (step 244); aggregating the pixels based on proximity to obtain defect segments or scratch segments (step 246); and providing an output including any of the defect segments or scratch segments (step 248).

The method 240 can further include a step of, based on applicable industry standards in terms of a number of defects and scratches and their corresponding size and location, providing a pass or fail assessment of the end-face of the optical fiber. The providing the output step can include providing an output image including the end-face of the optical fiber and an overlay showing any of the defect segments or scratch segments. The any of the defect segments or scratch segments can be visually distinguished in the overlay.

The method 240 can further include steps of, prior to the analyzing and during training of the pre-trained neural network model, obtaining augmented images that include real images of end-faces of optical fibers which are augmented with data including synthetic defects or scratches and which are labeled accordingly; and training the neural network model with the augmented images. The steps can further include creating the augmented images by obtaining real images of an end-face of an ideal optical fiber; adding synthetic defect and scratches to the real images to create training images with appropriate labels; and training the neural network model via supervised learning using the training images with the appropriate labels.

The method 240 can further include steps of determining if one or more stress rods or any other structural elements are present in the optical fiber; and masking or ignoring any pixels representing the one or more stress rods from further analysis. The analyzing the image with the pre-trained neural network model to classify pixels can include rotating the image multiple times and processing the rotated image accordingly with the pre-trained neural network model.

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A method of inspecting fibers, the method comprising steps of:
obtaining an image of an end-face of an optical fiber;
analyzing the image with a pre-trained neural network model to classify pixels therein as any of a defect, a scratch, or clean;
aggregating the pixels based on proximity to obtain defect segments or scratch segments; and
providing an output including any of the defect segments or scratch segments.

2. The method of claim 1, wherein the steps further include:
based on applicable industry standards in terms of a number of defects and scratches and their corresponding size and location, providing a pass or fail assessment of the end-face of the optical fiber.

3. The method of claim 1, wherein the providing the output includes:
providing an output image including the end-face of the optical fiber and an overlay showing any of the defect segments or scratch segments.

4. The method of claim 3, wherein the any of the defect segments or scratch segments are visually distinguished in the overlay.

5. The method of claim 1, wherein the steps further include:
prior to the analyzing and during training of the pre-trained neural network model, obtaining augmented images that include real images of end-faces of optical fibers which are augmented with data including synthetic defects or scratches and which are labeled accordingly; and
training the neural network model with the augmented images.

6. The method of claim 5, wherein the steps further include creating the augmented images by:
obtaining real images of an end-face of an ideal optical fiber;
adding synthetic defects and scratches to the real images to create training images with appropriate labels; and
training the neural network model via supervised learning using the training images with the appropriate labels.

7. The method of claim 1, wherein the steps further include:
determining if one or more stress rods or any other structural elements are present in the optical fiber; and
masking or ignoring any pixels representing the one or more stress rods from further analysis.

8. The method of claim 1, wherein the analyzing the image with the pre-trained neural network model to classify pixels includes rotating the image multiple times and processing the rotated image accordingly with the pre-trained neural network model.

9. The method of claim 1, wherein the aggregating the pixels based on proximity utilizes segmentation maps.

10. An optical fiber inspection device comprising:
an end-face imaging device configured to capture an image of an end-face of an optical fiber;
a processing device;
a memory device configured to store a computer program having instructions that enable the processing device to execute steps of:
obtaining an image of an end-face of an optical fiber;
analyzing the image with a pre-trained neural network model to classify pixels therein as any of a defect, a scratch, or clean;
aggregating the pixels based on proximity to obtain defect segments or scratch segments; and
providing an output including any of the defect segments or scratch segments.

11. The optical fiber inspection device of claim 10, wherein the steps further include:
based on applicable industry standards in terms of a number of defects and scratches and their corresponding size and location, providing a pass or fail assessment of the end-face of the optical fiber.

12. The optical fiber inspection device of claim 10, wherein the providing the output includes:
providing an output image including the end-face of the optical fiber and an overlay showing any of the defect segments or scratch segments.

13. The optical fiber inspection device of claim 12, wherein any of the defect segments or scratch segments are visually distinguished in the overlay.

14. The optical fiber inspection device of claim 10, wherein the steps further include:
prior to the analyzing and during training of the pre-trained neural network model, obtaining augmented images that include real images of end-faces of optical fibers which are augmented with data including synthetic defects or scratches and which are labeled accordingly; and
training the neural network model with the augmented images.

15. The optical fiber inspection device of claim 14, wherein the steps further include creating the augmented images by:
obtaining real images of an end-face of an ideal optical fiber;
adding synthetic defects and scratches to the real images to create training images with appropriate labels; and
training the neural network model via supervised learning using the training images with the appropriate labels.

16. The optical fiber inspection device of claim 10, wherein the steps further include:
determining if one or more stress rods or any structural elements are present in the optical fiber; and
masking or ignoring any pixels representing the one or more stress rods from further analysis.

17. The optical fiber inspection device of claim 10, wherein the analyzing the image with the pre-trained neural network model to classify pixels includes rotating the image multiple times and processing the rotated image accordingly with the pre-trained neural network model.

18. The optical fiber inspection device of claim 10, wherein the aggregating the pixels based on proximity utilizes segmentation maps.

19. A non-transitory computer-readable medium comprising instructions that, when executed, cause one or more processing devices to perform steps of:
obtaining an image of an end-face of an optical fiber;
analyzing the image with a pre-trained neural network model to classify pixels therein as any of a defect, a scratch, or clean;
aggregating the pixels based on proximity to obtain defect segments or scratch segments for further analysis/characterization; and
providing an output including any of the defect segments or scratch segments.

20. The non-transitory computer-readable medium of claim 19, wherein the steps further include:
based on applicable industry standards in terms of a number of defects and scratches and their corresponding size and location, providing a pass or fail assessment of the end-face of the optical fiber.
